(19) United States
(12) Patent Application Publication
(10) Pub. No.: US 2003/0034990 A1
(43) Pub. Date: Feb. 20, 2003

(54) Nonlinear display method for data of infinite extent

(76) Inventor: Gregory Robert Roelofs, San Jose, CA (US)

Correspondence Address: Corporate Patent Counsel, U.S. Philips Corporation, 580 White Plains Road, Tarrytown, NY, 10591, US

(21) Appl. No.: 09/932,082

(22) Filed: Aug. 17, 2001

(51) Int. Cl. G09G 5/00

(52) U.S. Cl. 345/660

(57) ABSTRACT

A method and system for displaying a data set of infinite extent on a display means of finite dimensions, and for providing navigation and magnification of the data set. The system comprises a control unit that receives a data set that is too large to display on a display of finite dimensions. The control unit maps at least a displayable portion of data points contained in the data set onto the display by applying a mathematical equation comprising a nonlinear and continuous mathematical function having a finite range and at least one independent variable of infinite domain. The displayable portion of the data points is displayable on the display and is determined by selecting one of the data points in the data set to correspond to a reference position on the display. The data set is traversed on the display by changing the selected data point that corresponds to the reference position.

### FIELD OF THE INVENTION

The invention relates to a system and method for the display of data of infinite extent, and in particular, to a system and method for nonlinear traversal and magnification of selected areas of dynamic data of infinite extent.

### DESCRIPTION OF RELATED ART

There are difficulties associated with the viewing of large data sets on a display, moving through the data and accessing desired data. These difficulties are compounded when viewing data sets of an infinite extent such as a timeline that extends into the future and/or past. The computer display is limited in size thus limiting the amount of data to be displayed.

There exist certain methods for magnifying selected portions of data that are too large to resolve and/or display when the data is presented on a display. In one method a selected area is magnified and overlays adjacent data. This, of course, has the disadvantage of obscuring the view of all or part of the adjacent data. In another method, a selected area is enlarged, which also serves to dislocate portions of the remaining data out of the field of view. This also obscures the remaining or adjacent data from being viewed. Another method magnifies a select area while compressing other adjacent areas. While this does not obscure the adjacent data, the implementation of this method serves to distort the adjacent data. It also tends to disturb the presentation of the relative positioning in certain cases, such as where the magnitude of magnification and compression are available in only discrete predetermined values. Neither technique provides a display (or even a representation) of a data set having a number of data points that is too large to display and/or has data points of magnitude that increases to a high or unlimited magnitude. U.S. application 4,790,028 provides a display in which segments of displayed data are either magnified or compressed by using different scaling functions. While no data is lost from the total viewing area, only a finite set of data is treated.

### SUMMARY

Thus, there is a need for a computer user to be able to view selected data in detail on a display, while still knowing the relative position of the selected data within a larger data set that cannot be viewably displayed in its entirety on the display.

There exists the need for providing a display of a data set of a large or infinite extent in which selected areas can be enlarged, while maintaining a display of the selected area relative to the data set and without obscuring pertinent data from the data set from view.

It is an object of the current invention to provide a system and a method for displaying on a display having a finite extent a data set that has a large or infinite extent.

It is a further object of the current invention to provide a system and a method for enhancing or magnifying on the display a portion of the data set, so that the data included in the enhanced portion can be readily viewed and accessed on the display, while the remaining data is compressed in a continuous manner until it cannot be further resolved on the display. Thus, the position of the enhanced portion of the data is maintained relative to the remaining portions, for example.

It is a further object of the current invention to provide for navigation through a data set of large or infinite extent on a finite display.

It is a further object of the current invention to provide a magnitude of magnification and compression of a data set of infinite extent, which follows a continuous function.

It is a further object of the current invention to provide continuous navigation through a data set of infinite extent according to a curved asymptotic function.

Accordingly, the present invention provides a system that displays a data set of a large or infinite extent on a display of finite dimensions. The system and method provides navigation and enhancement of select portions of the data, while maintaining its spatial relationship with the remaining portion of the data that is viewable on the display. The invention comprises a control unit, controller, processor or other computing device that receives a data set of large or infinite extent. The control unit maps at least part of the large or infinite data set into a finite range by applying a mathematical equation to the data of the data set, the equation comprising a mathematical function having a finite range and at least one independent variable of infinite domain. Thus, the data points of large or infinite extent in the data set are incorporated in the at least one independent variable of the function in the mapping. The mapping may provide a relatively expanded scale for the data about a central data point as mapped, for example, which scale is continually reduced (to an infinitesimal extent) on each side of the central data point as it approaches the finite limits of the range of the mathematical equation.

The mathematical equation generally comprises the mathematical function and scaling parameters that are adjusted in accordance with dimensions of the display, as well as the appearance of the data set on the display. The mathematical equation thus also has a finite range over the at least one independent variable of infinite domain of the mathematical function. Thus, the mathematical equation may be displayed on the finite display, for example, along at least one axis of the display. The processor provides the mapped data to the display for displaying the data set in at least one axis. Thus, in the example of the function that maps about a central data point given above, the display may display the mapped central data point at the center of the display. The remaining data in the large or infinite data set that is mapped to the left and right of the central data point is displayed to the left and right of the central data point on the at least one axis of the display. Because the range of the equation is bounded and scaled to the at least one axis of the display, the mapped data in the set is all contained within the display.

In the example of the function that maps about a central data point given above, the scale of the mapping is continually reduced to an infinitesimal extent as it approaches the limits of the range of the mathematical equation on each side of the central data point. Consequently, the scale of the axis of the mapped data on the display becomes infinitesimal at each end. Thus, the data from the data set as mapped onto the at least one axis of the display may become unresolvable. The processor may therefore provide a displayable portion of the mapped data to the display that comprises the mapped data to the left and right of the central data point that is resolvable on the display. The processor may further receive an input that changes the parameters of the mathematical function, such as the central data point and the scaling parameters. By changing these parameters, the displayable portion of the data set may be shifted and the degree of magnification along the axis of the display is redistributed, for example, so that there is a different central data point displayed with a relatively expanded scale at the center of the display.

The system may provide an interface for allowing the user to enter data and change variables that affect the display, by providing the input to the processor, and for providing a graphic user interface to allow the user to easily traverse to and magnify the specific data that the user intends to, for example as in zooming in, as well as to de-magnify data, for example, as in zooming out.

The display may further include at least one secondary axis, in addition to the axis (primary) described above, for displaying a portion of the data displayed on the primary axis. The display of the secondary axis may use the same mathematical function as for the primary axis, in which the parameters of the mathematical function are selected to be different from those selected for the primary axis, such as for providing a view zooming in or out of the portion of the data displayed on the primary axis. The secondary axis may be slaved to the primary axis so that the central data points are the same for both axes. The mathematical function used for the secondary axis may be a different function than is used for the primary axes, for example, a different nonlinear or a linear function. The secondary axis may use a function that has different scaling or magnification parameters but is otherwise the same or a similar function as used for the primary axis.

The invention also includes a system comprising a control unit that receives a data set that is too large to display on a display of finite dimensions. The control unit maps at least a displayable portion of data points contained in the data set onto the display by applying a mathematical equation comprising a nonlinear and continuous mathematical function having a finite range and at least one independent variable of infinite domain. The displayable portion of the data points is displayable on the display and is determined by selecting one of the data points in the data set to correspond to a reference position on the display. The data set is traversed on the display by changing the selected data point that corresponds to the reference position.

The invention also comprises a method for displaying on a display of finite dimensions a data set of extent too large to display on the display. The method comprises the steps of accessing a data set that is too large to display on a display of finite dimensions and mapping at least a displayable portion of data points contained in the data set onto the display by applying a mathematical equation comprising a nonlinear, continuous mathematical function having a finite range and at least one independent variable of infinite domain. The displayable portion of the data points are displayed on the display, and the data set is traversed on the display in a nonlinear and continuous fashion in accordance with the mathematical function by selecting one or more data points in the data set to correspond to a reference position on the display.

As noted above, the mathematical equation has a finite range over the at least one independent variable of infinite domain by virtue of the mathematical function having a finite range and at least one independent variable of infinite domain. Thus, the data points of large or infinite extent in the data set are incorporated in the at least one independent variable of the function in the mapping. The mapping may provide a relatively expanded scale for the data about a central data point as mapped, for example, which scale is continually reduced (to an infinitesimal extent) on each side of the central data point as it approaches the finite limits of the range of the mathematical equation.

The finite range of the mathematical equation is scaled so that it may be displayed, for example, on a finite display. The mapped data may be provided to the display for displaying the data set in at least one axis. Thus, in the example of the function that maps about a central data point given above, the display displays the mapped central data point at the center of the display. The remaining data in the large or infinite data set that is mapped to the left and right of the central data point is displayed to the left and right of the central data point on the at least one axis of the display. Because the range of the equation is bounded and scaled to the at least one axis of the display, the mapped data in the set is all contained within the display.

In the example of the function that maps about a central data point given above, the scale of the mapping is continually reduced to an infinitesimal extent as it approaches the limits of the range of the mathematical equation on each side of the central data point. Consequently, the scale of the axis of the mapped data on the display becomes infinitesimal at each end. Thus, the data from the data set as mapped onto the at least one axis of the display may become unresolvable. A displayable portion of the mapped data may therefore be provided to the display that comprises the mapped data to the left and right of the central data point that is resolvable on the display. An input that changes the parameters of the mathematical function may be received, such as the central data point and the scaling parameters. By changing these parameters, the displayable portion of the data set may be shifted, for example, so that there is a different central data point displayed with a relatively expanded scale at the center of the display, and so that the degree of magnification and compression along the axis of the display is redistributed.

In addition, the invention comprises a software application for processing a data set that is too large to display on a display of finite dimensions. The software application maps at least a displayable portion of data points contained in the data set onto a finite extent corresponding to the display by applying a nonlinear and continuous mathematical equation comprising a mathematical function having a finite range and at least one independent variable of infinite domain. The mapped values of the displayable portion of the data points are output for display. The software application receives an input of a selected data point that corresponds to a reference position on the display and uses the selected data point and the reference position to determine the remaining data points comprising the displayable portion. The software application outputs for display mapped values of data points in the data set corresponding to the displayable portion.

In addition, the invention comprises a server running a software application for processing a data set that is too large to display on a display of finite dimensions. The software application maps at least a displayable portion of data points contained in the data set by applying a nonlinear and continuous mathematical equation comprising a mathematical function having a finite range and at least one independent variable of infinite domain. The mapped values of the displayable portion of the data points are output for display. The software application receives an input of a selected data point that corresponds to a reference position on the display and uses the selected data point and the reference position to determine the remaining data points comprising the displayable portion. The software application outputs for display mapped values of data points in the data set for the corresponding displayable portion in accordance with the mathematical function.

The server may be a remote server in communication with a local server. Thus, the remote server receives input parameters delineating the displayable portion of the data set by a user at the local server. The remote server outputs to the local server a mapping of the displayable portion of the data set. The remote server may also receive an input corresponding to the selected data point by a user at the local server. The remote server outputs to the local server mapped values of data points in the data set being traversed in a nonlinear and continuous fashion in accordance with the mathematical function.

The software application may receive a continuous selection of consecutive data points as the data points corresponding to the reference position on the display and output mapped values of the data set to the corresponding displayable portion in a continuous fashion in accordance with the mathematical function. In this way, the data set is traversed in a nonlinear and continuous fashion.

The server may be a remote server of a website, and the data set may be generated at the website. Alternatively, the server may be a local server in communication with a remote server of a website, and the data set may be provided to the local server from the remote server.

### BRIEF DESCRIPTION OF THE DRAWINGS

The above and other objects, features and advantages of the present invention will become more apparent in light of the following detailed description of an exemplary embodiment thereof taken in conjunction with the attached drawings in which:

FIG. 1 is a representative diagram of the system according to the present invention;

FIG. 2 is a graph of an exemplary function used in the processing of an embodiment of the invention; and

FIGS. 3a-3c are exemplary embodiments of displays having different scaling parameters generated in accordance with embodiments of the present invention; and

FIG. 3d is the display as scaled in FIG. 3a having a different central data point.

### DETAILED DESCRIPTION

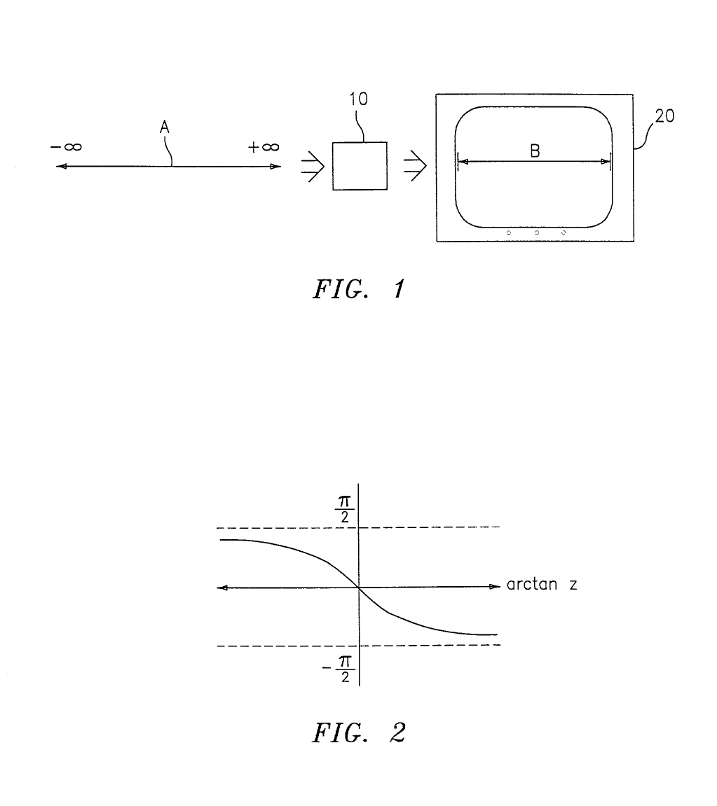

Turning now to the drawings, FIG. 1 depicts a system in accordance with an embodiment of the present invention comprising a control unit 10 and a display 20 having a finite horizontal width B. The control unit 10 receives as input a one-dimensional data set A of indefinite or infinite extent and maps the data set A (or a displayable portion thereof) onto the finite width B of display 20.

The control unit 10 is any computing device, from a single microprocessor or microcontroller to a computer system distributed over multiple processing nodes. The control unit 10 is capable of receiving data set A, processing data set A and transmitting the processed data to be displayed in accordance with the invention. Processing by the control unit 10 is generally performed using software or a software application. The control unit 10 is further able to generate data for the data set A. For example, if the data set A is years, the control unit 10 may generate successive years in a simple software loop that increments and/or decrements the current year by one.

As will be described in greater detail below, a user interface may be provided for allowing a user to communicate with the control unit 10 in order to enter data into the data set and controlling the display of the data set, for example, by traversing the displayed data of the data set and magnifying desired portions of the displayed data. The user interface comprises conventional means for interfacing with a computer such as a Graphical User Interface, a keyboard, a mouse, a joystick and a touch screen. Storage devices such as disk drives, CD drives, etc., having data stored, such as in a data file, may also provide the data set, or data for the data set, to the control unit 10.

The display 20 is any device for producing a display or printout in which the display or printout has a finite dimension, as in for example a computer monitor, a projection display, PDA and a printer.

The data set A may be “dynamic” in that the elements of data set A can change, such as in adding new elements, removing existing elements and/or replacing elements. For example, data set A may have data points comprised of years (a first dimension) and an associated temperature (a second dimension). The years may extend indefinitely into the past and future. The temperature data may include actual average temperature readings for the associated years, predicted temperatures for future years and calculated temperatures according to models for years in the past that preceded actual recorded readings. As models for calculating historical and future temperatures change, so do the temperature values of the data set. Furthermore, new readings may be added to the data set. Thus, the data of data set A may be considered to be in flux. In another example, the first dimension of data set A may be enlarged to include the days of each year (within a selected sub-set of data set A) upon zooming in on a selected sub-set A.

The data set A may be a data set of indefinite or infinite or large extent. A data set of indefinite or infinite extent includes a potentially unbounded number of data points, and also includes data points of magnitude that increase without limit. A data set of “large extent” generally includes a data that cannot be completely resolved by and/or contained within the display when displayed in a conventional manner on the finite dimension of the display (for example, a conventional manner of displaying the data set is using an axis on the display that has a linear scale). This may be due to the large number of data points in the data set, the range of the data points in the data set, or a combination thereof. The data set A may be input in whole or in part and/or may be calculated by the control unit 10 in whole or in part. For example, data set A may be the set of days, months, years, or other time unit extending indefinitely into the past and future. In the exemplary embodiment now described, the data set A comprises the years themselves. Such a data set may be considered infinite (in both magnitude and number of data points) or having a large extent (if bounded, for example, by hundreds or thousands of years). As described further below, the data set may be multi-dimensional, for example where the data points comprise other data associated with all or some of the years.

The data set A can be updated by a user interfacing with the control unit 10 (for example, using a computer). In a simple embodiment, the user may select an unbounded data set of years and the control unit 10 may generate (via a software program) the data set for all past and prior years. In another example, the user may select the dates for every first Tuesday of every month between 100 years in the past and 100 years in the future. The control unit 10 may have a calendar program that enables it to access and/or generate dates from the past and future, thus providing the data set. In general, only a subset of data set A is generated and stored by the computer, thus avoiding an infinite programming loop. The subset may include data that was entered by the user, such as the central data point further described below. It may also include the displayable portion of the data set as further described below. In such cases, other data of data set A, such as one or more dates outside of the displayable portion (which may be further out into the future or past), is calculated by the control unit when required, as described further below.

A function having a finite range for an unbounded independent variable input is used to map the data set having infinite or very large extent onto the finite dimension B of the display 20. For example, the function may be arc tan z, where z takes on the values of the data points in the data set of infinite or very large extent. The range of the function arc tan z is between −π/2 and +π/2; thus, any value of z in the data set, no matter how large (or small), is mapped onto a finite range. Additional examples of functions having infinite limits include are cot z, tanh z, and sinh⁻¹ z. Where specified in the embodiments below, the arc tan function will be used.

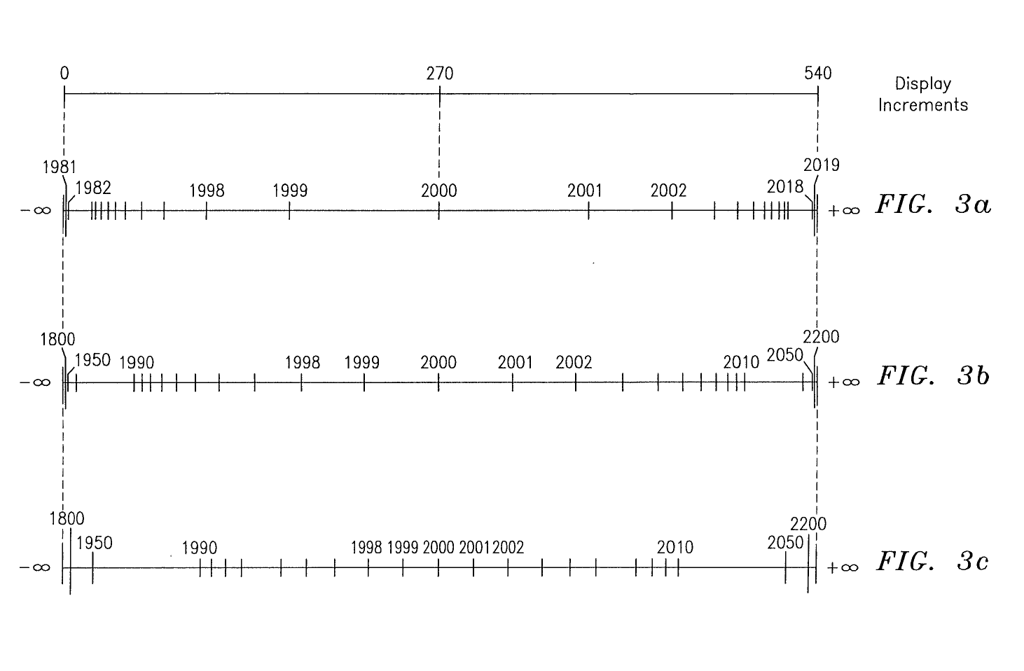

FIG. 2 is a graph of arc tan z for [−∞≦z≦+∞]. FIG. 2 illustrates that as z approaches positive infinity, the function arc tan z approaches +π/2, and as z approaches negative infinity, the function arc tan z approaches −π/2. Thus, the function arc tan z has the finite range [−π/2,π/2]. Consequently, by applying the function arc tan z, an infinite data set (such as data set A) may be mapped onto an axis having a finite length correlating to the finite interval [π/2,π/2]. Thus, the left end of the axis correlates to the −π/2 boundary of the image and the right end of the axis correlates to the π/2 boundary of the image. Accordingly, the axis can have a finite extent within the width of the screen of a computer display, wherein the left side of the screen may correlate to the −π/2 boundary of the image, and the right side of the screen may correlate to the π/2 boundary of the image. Of course, the axis may be scaled, for example, by using the function as part of a more comprehensive mathematical equation, as described further below. It is also possible to orient the axis upon which the data set is plotted to be in any direction.

The application of the method of the present invention will be illustrated with an example wherein the data set is the set of years extending into the past to negative infinity and into the future to positive infinity. The data set is plotted on a one-dimensional axis, an x-axis, displayed on a computer display. The x-axis spans the width of the screen.

In one embodiment, the mathematical equation used by the control unit 10 for mapping the infinite data set t (where t is the set of time increments from −∞ to +∞) onto the display of finite width is as follows according to the following equation:

x={(xₘₐₓ/π)*arc tan ((t−t₀)/K)}+xₘₐₓ/2 (Eq. 1)

wherein

x is the location of data point t on the horizontal axis (x-axis) of the display, from the left-hand side of the axis, ranging from 0 to xₘₐₓ;

t is any time data point selected from the data set;

t₀ is the time data point displayed at the midpoint of the x-axis;

xₘₐₓ is the length of the x-axis on the display;

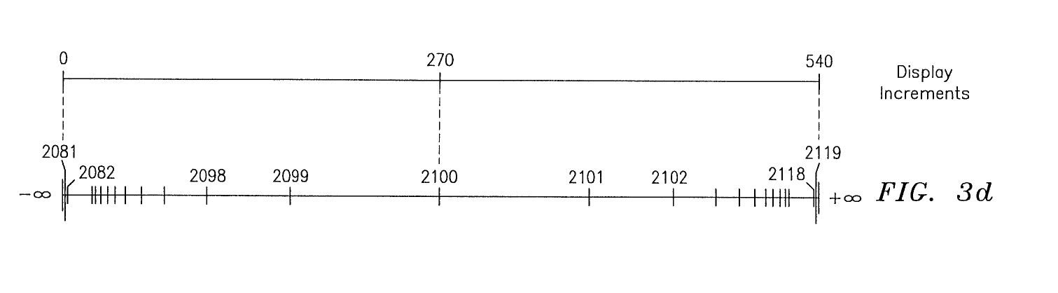

K=(one time increment)/tan (m*π),

where M is a percentage scaling factor, m=M/100 and “one time increment” is the constant time interval between data points.

Where the time increment is one year, then the data set t is the set of years from from −∞ to +∞. The value to may be, for example, the year 2000. For a computer display that has a horizontal width of approximately 12.5″, the length of the x-axis on the display xₘₐₓ may be, for example, 7.5″, thus fitting comfortably within the display and having space for margins. FIGS. 3a-3c shows three different displays of the data set t as mapped by the control unit 10 onto the horizontal x-axis of the display using Eq. 1 above, with the constant time interval being a year. In determining the positions of the years displayed along the x-axis, it is convenient to divide the x-axis into units that correspond to the display increments of the display. For example, where the display is an LCD display, the display increment along the x-axis may be an LCD pixel. For an LCD display having 72 pixels per inch, for example, xₘₐₓ=72*7.5=540. Thus, in units of display increments (or LCD pixels in this example), the length of the x-axis is from 0 to 540 LCD units (referred to as “x-units”).

Referring to the mapping of the data set t as displayed on the x-axis as shown in FIG. 3a, the values used for M=20%, thus giving m=0.2 and K=1 year/tan (π/5)=1/.72654 years=1.376 years. As noted, t₀=2000 and xₘₐₓ=540. Thus, Eq. 1 as applied becomes:

x={(540/π)*arc tan ((t−2000)/1.376)}+270 Eq. 2a

When t=2000, then FIG. 2 shows that arc tan (0)=0 and x=270. Thus, year 2000 is mapped to the center of the x-axis (at position 270), as expected and shown in FIG. 3a. As t increases above 2000, the years are shown becoming mapped closer together along the x-axis because of the finite range of the arc tan function. When t approaches +∞, then FIG. 2 shows that the arc tan function approaches π/2, and x approaches {(540/π)*π/2}+270, which equals 540, as expected and shown in FIG. 3a. Thus, the years above 2000 in the data set are all mapped along x-unit 270 to 540 on the x-axis. Similarly, as t decreases below 2000, the years are shown becoming mapped closer together along the x-axis because of the finite range of the arc tan function. When t approaches −∞, then FIG. 2 shows that the arc tan function approaches −π/2, and x approaches {(540/π)*−π/2}+270, which equals 0, as expected and shown in FIG. 3a. Thus, the years below 2000 in the data set are all mapped along unit 270 to 0 on the x-axis.

Where Eq. 2a does not give an x unit that is an integer for an input year t, the control unit 10 (via software programmed therein) will round to the nearest x-unit in generating the display. The control unit 10 may map as many years as needed above and below the year 2000 (t₀) in Eq. 2a to generate the display as shown in FIG. 3a. However, although the data set t may be infinite, the control unit 10 will not map an infinite number of years above and below the year 2000 (or, in general, the central data point t₀). As t increases and is mapped closer to the right-hand side of the x-axis (i.e., closer to 540), at some threshold year more than one year will be mapped to a single x-unit. The number of years mapped to each successive x-unit will then continue to increase as the right-hand limit (unit 540) is approached. (By the time unit 540 is reached, the infinite number of years remaining in the data set are mapped to the single time unit 540) Thus, at some year t above 2000, the mapping may become unresolvable for purposes of the display. (By the symmetry of Eq. 2a, the same occurs at the left-hand side of the display (as x-unit 0 is approached) as the years t decrease below 2000. Thus, at some year t below 2000, the mapping also becomes unresolvable for purposes of the display.)

For example, as years increase above 2000 using the mapping of Eq. 2a and rounding to the nearest x-unit (pixel):

year t=2015 is mapped to position x=524;

year t=2016 is mapped to position x=525;

year t=2017 is mapped to position x=526;

year t=2018 is mapped to position x=527;

year t=2019 is mapped to position x=528;

year t=2020 is mapped to position x=528;

year t=2021 is mapped to position x=529;

year t=2022 is mapped to position x=529; etc.

Thus, after year 2018, more than one year is mapped to a pixel (x-unit) and cannot be physically resolved by the display. (It is noted that the resolution refers to the display capabilities, not the viewer, whose eyes may not be able to resolve the years even sooner than the year 2018.) Accordingly, the control unit 10 may map years 2000-2018 to the corresponding x-unit and then simply “fill in” x positions 528-540, since these pixels represent the mapping of the remaining years 2019 to +∞ (a sub-set of the data set), which cannot be separately resolved by the display. By symmetry, the same may occur for years 2000-1982 and data sub-set 1981 to −∞ on the left-hand side of the display.

Accordingly, in generating the display of the data set on the x-axis, the control unit 10 may only map those years above and below the central data point that are resolvable by the display increments of the display, referred to as the “displayable portion” of the data set. The balance of the years on the right and left of the display are simply displayed as a solid line (or other visual representation) that represents the remaining data points out to +∞ and −∞. In order to rapidly accommodate scrolling through the data set or other re-setting of the central data point or other scaling parameters by the user, as described further below, the control unit 10 may map and store additional data points above and below the displayable portion of the data set.

Alternatively, only select data points may be displayed on the axis, which can alleviate or eliminate the crowding of data points represented at the edges of the range. As shown in FIG. 3a, each year in the data set is displayed using a small “tick mark”, with the year above it. As the left and the right sides of the display are approached, not every year in the data set need be displayed. For example, after year t=2015 is mapped to position x=524 in the above example, the next year mapped on the display may be year t=2024, mapped to position 530. The next year displayed may be year 2047 mapped to position 535, and the final tick mark on the display may represent “+∞” at position 540. Other intervals between data points of varying length (or omissions of data points) may be selected.

FIGS. 3b and 3c demonstrate how the display of the data set changes when the scaling parameters of Eq. 1 are changed. In FIG. 3b, M=10%, m=0.1 (thus K=3.078) and Eq. 1 becomes:

x={(540/π)*arc tan ((t−2000)/3.078)}+270 Eq. 2b

In FIG. 3c, M=5%, m=0.05 (thus K=6.314) and Eq. 1 becomes:

x={(540/π)*arc tan ((t−2000)/6.314)}+270 Eq. 2c

Referring to FIG. 2, a larger denominator K in the arc tan function maps more years toward the central data point, as shown in succession from FIGS. 3a to 3c. In addition, more years are resolvably displayed at the left and right portions of the display as K increases. In all cases, although the displayed x-axis has a finite length determined according to the mathematical equations Eq. 2a-2c, the years represented from the data set extend (conceptually) at the right and left of the displayed axis to infinity and negative infinity respectively.

The years in the data set may be traversed without limit, for example, by shifting the display of the data set t to the left or right by selecting a time value to replace the current t₀ as the central data point. The amount by which the displayed data set may be shifted may be unlimited. The new value for t₀ may be input by the user, for example, by a keyboard of a computer, by a GUI that integrates the current display on screen, or by clicking a year on the current display on screen. The control unit 10 may completely regenerate the display by mapping the data set onto the horizontal x-axis of the display by using the new central data point t₀ in Eq. 1 (or Eqs. 2a-2c where those scaling parameters are selected). Alternatively, because the relative positions of the surrounding years will not change with respect to t₀, it is simpler for the control unit 10 to simply replace the year at the central position (270 for FIGS. 3a-3c) with the new central data point (year), and then renumber the years at the x-units to the left and right of t₀ based on the new value of t₀. For example, for the display generated using the scaling parameters in Eq. 2a as depicted in FIG. 3a for t₀=2000, FIG. 3d shows the display of the data set where t₀ is shifted to 2100. The display of FIG. 3d is generated by simply adding 100 to each of the years as displayed in FIG. 3a.

The display of the data set t is scalable by selecting the value for the scaling factor M, which serves to change the value K. Other parameters in Eq. 1 that may be adjusted include the display resolution xₘₐₓ (for example, by using different displays) and the time increment (which generally changes the data set being mapped). The scale of the display of the data set may be adjusted in a continuous fashion in accordance with the mathematical function upon continuous selection of consecutive values for the scaling factor and/or the time increment. M can take on any value between zero and infinity, providing an unlimited degree of scaling of the time line for zooming in or zooming out. Other examples of data sets (and the associated time increment pertinent to Eq. 1) include millennia, centuries, decades, months, weeks, days, hours, minutes, seconds, nanoseconds, etc. For example, with the time unit selected to be a year, selection of a small scaling factor M (larger K) allows a greater range of time to be viewable (resolvable) on the display, as was shown by the progression from FIGS. 3a to 3c. Conversely, by selecting a large scaling factor M (smaller K) the years surrounding the central data point are viewable in greater detail, but there are fewer years viewable. By changing the time unit to be a century, a much larger range of time is viewable on the display, of course, but will generally be viewable in lesser detail. By changing the time unit to a day, the display has greater detail, however with a much smaller range of time viewable.

By shifting the central data point as described above and selecting the scaling factor M, points in the data set may be accessed and viewed on the display without limit. For a data set of time increments, such as years as in the embodiments above, the time increment may also be adjusted, thus allowing the user and/or system to refine or expand the time displayed.

As mentioned, the displayed data set may be traversed using a variety of methods. The displayed data set may also be scaled (by changing the scaling parameters in the mapping, such as in Eq. 1) in like manner. The computer user may select the degree of shifting and scaling via a Graphical User Interface (GUI). There are a large variety of GUI features that are suitable to use. For example, thumb wheels, levers or arrow pairs may be displayed on a user's screen, one for adjusting the magnification (scaling) factor M and one for selecting a position on the timeline 100 (thus selecting a value for t₀) in the example of a data set of time increments. Where the time increment of the data set is adjustable, another GUI feature may be used to adjust the time increment up or down. The GUI features may be used to continuously select consecutive values for the scaling factor, the data point mapped to a reference position (such as t₀) and/or the time increment. A position indicator, such as a cursor, may be provided for indicating a location on the data set as currently displayed. Upon positioning the position indicator on the display, the display is re-adjusted to the left or right so that the year (or other time increment or data point) being pointed to becomes the central data point displayed. The position indicator may be used to select a single desired point from the data set on the display or the processing may scroll the displayed data points until the data point corresponding to the position indicator becomes the central data point. The GUI may be controlled via user interface devices such as a keyboard, mouse, joystick, touch screen, microphone and voice recognition software, etc. Furthermore, it is desirable to provide the user with the ability to directly enter the values for M, t₀ and the time unit, for example, using a keyboard and a menu.

When traversing the data set displayed, it is traversed in a nonlinear (due to the equation used in the mapping) and continual fashion. The further the position of the position indicator is from t₀, the more closely spaced are the time intervals, as previously noted. (For example, as the left and right sides of the display are approached in FIGS. 3a-3c, the data points approach −∞ and +∞) If the position indicator is maintained at a point toward the left or right side of the display (such as the displays of FIGS. 3a-3c), the control unit 10 may continuously scroll the years across the display until the position indicator is removed.

In another embodiment, an accelerated “rubber band” effect is achieved using the well-known method of clicking at a desired point on the display and dragging a point (using, for example, a mouse). As the pointer is dragged farther from t₀, the display shifts faster. The shifting display may be generated by successively re-mapping the data set t using a sequence of values for t₀ in Eq. 1. For example, the year in the data set nearest the pointer on the display may be used as t₀ in Eq. 1 for the successive mappings of the data set used to generate the display. As the mouse is dragged further from the t₀ position, the interval between to in successive mappings increases, thus, the movement appears to be faster. Alternatively, the control unit 10 may simply shift the years across the pertinent x-units of the display (as described above with respect to FIG. 3d) and correlate the shifting speed to the distance between the pointer and the t₀ position.

In addition, when zooming in on a selected time, a coarse display may be provided at the top of the screen for indicating the overall position of the current position on the display. A secondary display may be provided at a peripheral section of the display for providing a zoomed-in view. The secondary display may use a different mathematical function than the original display. The mathematical function used by the secondary display may be nonlinear or linear. It is possible to provide multiple levels of the displayed data set in this fashion.

The data set may be scaled in like manner using a GUI or other input interface. By adjusting the scaling factor M (and thus parameter K in the mapping of Eq. 1, for example), the displayed portion and look of the data set may be changed. The time increment (and thus the data set that is mapped) may also be adjustable by the user, as previously discussed. It may also be automatically adjustable, for example, when the display is scaled (via parameter M in Eq. 1, for example) such that the spacing between t₀ and the next data point increases beyond a predetermined amount, the time increment may automatically be adjusted to a smaller unit, such as from a year to a month by the control unit 10. The scaling parameters of Eq. 1 may be adjusted by the control unit such that the first twelve months to the left and right of to correspond to the year interval that is being replaced. It is possible for the data displayed at the center of the display to be different from the time unit used near the end portions of the timeline. It is also possible to display the data using different time units at different portions of the display according to the size of the interval on the axis between displayed values.

As noted, the displays shown in FIGS. 3a-3c use tick marks to indicate the positions of the data points as mapped on the x-axis. The tick marks correspond to the pixels or x-units as calculated using Eqs. 2a-2c. As noted above, attempting to map each point in the data set typically will become unresolvable by the display after moving a certain distance from the central data point near the left or right of the x-axis. If each data point is represented, the tick marks will appear continuous near the edges of the display. As also noted above, not every data point need be represented on the display, especially near the edges where a large number are compressed (by the non-linear function) into a small display interval. Yearly labels (or other time increment) may be provided for all or selected tick marks. The tick marks and labels displayed may be selected according to the level of compression of the display data set. The user may select the spacing of tick marks and labels for a display or printout.

Although the tick marks and labels are discrete indicators for selected values of the data set displayed, the data set can be conceived as a continuous data set. Each point (for example, a data point corresponding to a particular pixel) on the x-axis corresponds to a time value (such as represented by a rational number). The time value increments between points on the x-axis is determined by the degree of magnification. The degree of magnification and the selection of time increments may be unlimited and selectable for changing in a continuous fashion; likewise, time value increments between points on the x-axis may be selected and changed in an unlimited and continuous fashion. Of course, the display resolution may impose a practical limitation on the time value increments that may be displayed between points on the x-axis.

In another embodiment, the data comprising the data set may have multiple dimensions, one or more of which have an infinite range and one or more of which have a finite range. A combination of mathematical functions may be used to map the data set to a single display. For example, the data set may be comprised of data points (d, h), where d has an infinite domain (such as daily dates that extend indefinitely into the past and/or future) and h has a finite domain (such as a particular time of day, measured by a 24 hour clock). The points d in the data set may be displayed on an x-axis by mapping using a function having a finite range for an infinite domain, as described above. The corresponding data points h may be displayed along the y axis using a linear scale, for example, since they never exceed 24. The linear scale, of course, corresponds to a mapping of the h data points using a linear function. In addition, the middle region of the display or printout of the infinite parameter d may use a linear function, while the outer region may use a nonlinear function having a finite range.

In another embodiment, where both (or more) dimensions in the data set have an infinite domain, the mappings to both the x and y axis of the display may each be made using equations having a nonlinear function of infinite domain but finite range, as described above. Maneuvering and scaling among the data on the display may be conducted in each dimension as described above. For three dimensions, the control unit 10 may render a third dimension on the display, while for four or more dimensions, the user may have to select a lesser number of dimensions for display on the display. The GUI may provide switching between dimensions.

While the above description has focused on data sets having a variable of infinite extent, the invention is likewise applicable to large data sets, ones that cannot be viewed and/or resolved in their entirety on a display. This may be due to the large number of data points in the data set and/or the relative magnitudes of at least some of the data points, which may lead to a large range of the data set. For example a data set of large extent may comprise the data set of all years between 0 and 10,000; all nanoseconds between 0 and 1 second; or x and y coordinates of a map of the United States having a resolution of centimeter (i.e. two large data sets: one large data set for each of the x and y coordinates) because of the large number of data points. A large data set may also comprise, for example, the data set of the years (1, 10, 9,999) or Kelvin temperatures having a range large enough to accommodate boiling and melting points of a variety of materials and a resolution of milliKelvin because of the large range. An infinite data set where the data is unbounded in one direction, may comprise, for example, the numbers corresponding to successively smaller decimal units of pi, or the set of negative integers. The data points in a large data set and a data set that is infinite in one direction may be treated in like manner to the infinite data set as described above. Thus, the data points in the large data set may be mapped using an equation that comprises a function of infinite domain but finite range. Even hierarchical data sets, such as a computer file system could be viewed in a continuous fashion, allowing a user to zoom from an overall view of the file system to a particular file without having to move through a succession of sub-directories individually.

In both cases, for the large data set or the data set having an infinite range, the processing of the control unit may not necessarily use a function having a finite range. In the case of a large data set, since there is an outer limit to the data points, a function having an infinite range may be used in the mapping with appropriate scaling. (Alternatively, different functions may be used in the mapping for different regions of the display.) Similarly, for a data set of infinite range, the processing may treat the data set as having a finite range. For example, for the data set t of years, the control unit may treat the data set as extending between −10,000 and +10,000. Again, a function having an infinite range may be used in the mapping with appropriate scaling.

As noted above, the control unit of the invention generally performs the processing referred to (such as the mapping provided by the various mathematical equations and functions) through suitable programming of the control unit, such as with software programming and/or software applications loaded in one or more memories of the control unit. An associated memory or database accessible by the control unit to perform the invention as described above is also considered to be part of the invention.

In another embodiment of the invention, the data set is provided to the control unit from a remote location such as a remotely located database, for example a database maintained by an Internet web-site.

In another embodiment of the invention, the processing performed by the control unit is provided as a service to users such as subscribing users. A remote server is provided that includes at least the control unit described above. A local server submits a request to the remote server to provide a mapping for a display of a large or infinite data set. The remote server accesses and processes the data of the large data set and provides the mapping for the display to the local server.

While the present invention has been described in detail with reference to the preferred embodiments, they represent mere exemplary applications. Thus, it is to be clearly understood that many variations can be made by anyone having ordinary skill in the art while staying within the scope and spirit of the present invention as defined by the appended claims.

What is claimed is:

1. A system comprising a control unit that receives a data set that is too large to display on a display of finite dimensions, the control unit mapping at least a displayable portion of data points contained in the data set onto the display by applying a mathematical equation comprising a nonlinear and continuous mathematical function having a finite range and at least one independent variable of infinite domain, the displayable portion of the data points being displayable on the display, the displayable portion being determined by selecting one of the data points in the data set to correspond to a reference position on the display, the data set being traversed on the display by changing the selected data point that corresponds to the reference position.

2. The system as in claim 1, wherein a first displayable portion of the data set is replaced with a second displayable portion of the data set when traversed.

3. The system as in claim 2, wherein data points in the data set between the data point corresponding to the reference position for the first displayable portion and the data point corresponding to the reference position for the second displayable portion traverse the displayable portion of the display in a continuous and non-linear manner in accordance with the mathematical function when traversed.

4. The system as in claim 1, wherein the reference position is a central position of the displayable portion of data points on the display.

5. The system according to claim 1, wherein the amount of data of the data set included in the displayable portion is adjustable in a nonlinear fashion in accordance with the mathematical function by adjusting one or more parameters of the mathematical function for scaling the mathematical function.

6. The system as in claim 1, wherein the data set comprises data points that are unbounded in at least one of magnitude and number.

7 The system as in claim 1, wherein the control unit maps data points of the data set onto the display as the at least one independent variable of the mathematical function.

8. The system as in claim 1, wherein the data set is too large to display due to the number of data points in the data set.

9. The system as in claim 1, wherein the data set is too large to display due to the range of data points in the data set.

10. The system according to claim 1, wherein the data set is one-dimensional and the data set is mapped onto the display as the at least one independent variable of the function.

11. The system according to claim 1, wherein the data set is multi-dimensional and at least one dimension of the data set is mapped onto the display as the at least one independent variable of the function.

12. The system according to claim 1, wherein the range of the mathematical equation is completely displayable on the display.

13. The system according to claim 1, wherein the displayable portion is mapped on an axis of the display and the scale of the axis continually changes.

14. The system according to claim 13, wherein the mapping provides a relatively expanded scale for the data mapped about the midpoint of the displayable portion, and a continually reduced scale on each side of the midpoint of the displayable portion as the mapping approaches ends of the axis.

15. The system according to claim 1, wherein the system further includes a user interface that provides input to the control unit, wherein the user interface allows the user to do at least one of entering at least some of the data points of the data set, changing the parameters of the mathematical equation and selecting the displayed data points.

16. The system as in claim 15, wherein the user interface comprises a GUI.

17. The system as in claim 16, wherein the mathematical equation has a finite range over the data set due to the mathematical function; and wherein the display displays at least one axis corresponding to the finite range of the mathematical equation and displays at least the displayable portion of the mapped data points on the axis.

18. The system according to claim 17, wherein the axis is marked and labeled at selectable and variable intervals to indicate the placement of values of displayable data points displayed on the axis.

19. The system according to claim 1, wherein the mathematical function is one selected from the group of arc tan, cot, tanh and sinh⁻¹.

20. The system according to claim 1, wherein the data set is traversed in a nonlinear and continuous fashion across the displayable portion in accordance with the mathematical function upon continuous selection of consecutive data points as the data point corresponding to the reference position on the display.

21. The system according to claim 20, wherein at least a portion of the consecutive data points are used as a reference position parameter in the mathematical function to calculate consecutive displayable portions of the data set in order to traverse the data set across the displayable portion in the nonlinear and continuous fashion.

22. A method for displaying on a display of finite dimensions a data set of extent too large to display on the display comprising the steps of accessing a data set that is too large to display on a display of finite dimensions; mapping at least a displayable portion of data points contained in the data set onto the display by applying a mathematical equation comprising a nonlinear, continuous mathematical function having a finite range and at least one independent variable of infinite domain; displaying the displayable portion of the data points on the display; and traversing the data set on the display in a nonlinear and continuous fashion in accordance with the mathematical function by selecting one or more data points in the data set to correspond to a reference position on the display.

23. A software application for processing a data set that is too large to display on a display of finite dimensions, the software application mapping at least a displayable portion of data points contained in the data set onto a finite extent corresponding to the display by applying a nonlinear and continuous mathematical equation comprising a mathematical function having a finite range and at least one independent variable of infinite domain, the mapped values of the displayable portion of the data points being output for display, the software application receiving an input of a selected data point that corresponds to a reference position on the display, the software application using the selected data point and the reference position to determine the remaining data points comprising the displayable portion, the software application outputting for display mapped values of data points in the data set corresponding to the displayable portion.

24. The software application according to claim 23, wherein the scale of the displayable portion is adjusted in a nonlinear and continuous fashion in accordance with the mathematical function by receiving an adjustment input that adjusts a parameter of the mathematical function.

25. The software application as in claim 23, wherein the data set comprises data points that are unbounded in at least one of number and magnitude.

26. The software application as in claim 23, wherein the software application maps the data points corresponding to the displayable portion as the at least one independent variable of the mathematical function.

27. The software application as in claim 23, wherein the data set is too large to display due to one of the range and number of data points in the data set.

28 The software application according to claim 23, wherein the software application receives input from a user interface, the user interface allowing the user to input at least one of 1) one or more data points of the data set, 2) a change of a parameter of the mathematical equation and 3) a selection of the displayed data points.

29. The software application as in claim 23, wherein mathematical equation has a finite range over the data set due to the mathematical function, the mapped outputs of the software application are formatted for a display that displays at least one axis corresponding to the finite range of the mathematical equation and displays at least the displayable portion of the mapped data points on the axis.

30. The software application according to claim 23, wherein the mathematical function is one selected from the group of arc tan, cot, tanh and sinh⁻¹.

31. The software application according to claim 23, wherein the software application receives a continuous selection of consecutive data points as the data points corresponding to the reference position on the display and outputs mapped values of the data set to the corresponding displayable portion in a continuous fashion in accordance with the mathematical function, wherein the data set is traversed in a nonlinear and continuous fashion.

32. A server running a software application for processing a data set that is too large to display on a display of finite dimensions, the software application mapping at least a displayable portion of data points contained in the data set by applying a nonlinear and continuous mathematical equation comprising a mathematical function having a finite range and at least one independent variable of infinite domain, the mapped values of the displayable portion of the data points being output for display, the software application receiving an input of a selected data point that corresponds to a reference position on the display, the software application using the selected data point and the reference position to determine the remaining data points comprising the displayable portion, the software application outputting for display mapped values of data points in the data set for the corresponding displayable portion in accordance with the mathematical function.

33. The server as in claim 32, wherein the server is a remote server in communication with a local server, the remote server receiving input parameters delineating the displayable portion of the data set by a user at the local server, the remote server outputting to the local server a mapping of the displayable portion of the data set.

34. The server as in claim 32, wherein the server is a remote server in communication with a local server, the remote server receiving an input corresponding to the selected data point by a user at the local server, the remote server outputting to the local server mapped values of data points in the data set being traversed in a nonlinear and continuous fashion in accordance with the mathematical function.

35. The software application according to claim 32, wherein the software application receives a continuous selection of consecutive data points as the data points corresponding to the reference position on the display and outputs mapped values of the data set to the corresponding displayable portion in a continuous fashion in accordance with the mathematical function, wherein the data set is traversed in a nonlinear and continuous fashion.

36. The server as in claim 32, wherein the server is a remote server of a website, the data set being generated at the website.

37. The server as in claim 32, wherein the server is a local server in communication with a remote server of a web site, the data set being provided to the local server from the remote server.

38. A system comprising a control unit that receives a data set that is too large to display on a display of finite dimensions, the control unit mapping at least a displayable portion of data points contained in the data set onto the display by applying at least a combination of linear continuous mathematical functions, at least one of the linear mathematical functions serving to model a nonlinear continuous mathematical function, the modeling serving to map onto the display a portion of the data set that is too large to display.
